(19) United States
(12) Patent Application Publication
(10) Pub. No.: US 2012/0239372 A1
(43) Pub. Date: Sep. 20, 2012

(54) EFFICIENT DISCRETE EVENT SIMULATION USING PRIORITY QUEUE TAGGING

(75) Inventor: Erik KRUUS, Hillsborough, NJ (US)

(73) Assignee: NEC LABORATORIES AMERICA, INC., Princeton, NJ (US)

(21) Appl. No.: 13/324,014

(22) Filed: Dec. 13, 2011

Related U.S. Application Data
(60) Provisional application No. 61/452,264, filed on Mar. 14, 2011.

(51) Int. Cl. G06G 7/62

(52) U.S. Cl. 703/17

(57) ABSTRACT

A method is provided for sequential discrete event simulation for a distributed system having a set of nodes. A priority queue is constructed that includes events to be executed by a processor at a given node in the set. A first subset of nodes is identified. Each node in the first subset is associated with a respective subset of events and includes a highest priority event whose priority must be unconditionally re-evaluated during a next time step. A second subset of nodes is identified. Each node in the second subset is associated with a respective other subset of events and includes a highest priority event whose priority must be re-evaluated when a re-evaluation condition depending upon an external state is satisfied. A next one of the plurality of events in the priority queue is selected to be executed by the processor using the first and second subsets of nodes.

### RELATED APPLICATION INFORMATION

This application claims priority to provisional application Ser. No. 61/452,264 filed on Mar. 14, 2011, incorporated herein by reference.

### BACKGROUND

1. Technical Field

The present invention relates to event simulation, and more particularly to discrete event simulation using priority queue tagging.

2. Description of the Related Art

Since current time changes frequently (usually at every simulation step), moving simulated time forward stepwise by asking each node to re-evaluate its currently proposed next action scales badly, O(N). Most simulators provide a better solution in form of support for simple finite state machines in nodes or self-messages that can be used to implement such policies at the expense of additional operations on the main queue. However, while O(1) queue insertion is possible, the number of such operations required to simulate many policies can be O(N), so replacing such operations by faster and fewer simpler operations is of interest. Alternate solutions involving rollback or agent-based simulation involve undesired re-engineering effort and would operate slower or require more resources (e.g., one or more parallel computers). A conceptually related approach is found in graph algorithms such as one prior art graph algorithm where vertex coloring is used to denote additional vertex related states.

### SUMMARY

These and other drawbacks and disadvantages of the prior art are addressed by the present principles, which are directed to discrete event simulation using priority queue tagging.

According to an aspect of the present principles, there is provided a method for sequential discrete event simulation for a distributed system having a set of nodes. The method includes constructing a priority queue that includes a plurality of events to be executed by a processor at a given node in the set. The method further includes identifying a first subset of nodes. Each of the nodes in the first subset is associated with a respective subset of events determined from the plurality of events and includes a highest priority event there among whose priority must be unconditionally re-evaluated during a next time step. The method also includes identifying a second subset of nodes. Each of the nodes in the second subset is associated with a respective other subset of events determined from the plurality of events and includes a highest priority event there among whose priority must be re-evaluated when a re-evaluation condition depending upon an external state is satisfied. The method additionally includes selecting a next one of the plurality of events in the priority queue to be executed by the processor using the first subset and the second subset of nodes.

According to yet another aspect of the present principles, there is provided a computer storage medium for storing programming code for a method for sequential discrete event simulation for a distributed system having a set of nodes. The method includes constructing a priority queue that includes a plurality of events to be executed by a processor at a given node in the set. The method further includes identifying a first subset of nodes. Each of the nodes in the first subset is associated with a respective subset of events determined from the plurality of events and includes a highest priority event there among whose priority must be unconditionally re-evaluated during a next time step. The method also includes identifying a second subset of nodes. Each of the nodes in the second subset is associated with a respective other subset of events determined from the plurality of events and includes a highest priority event there among whose priority must be re-evaluated when a re-evaluation condition depending upon an external state is satisfied. The method additionally includes selecting a next one of the plurality of events in the priority queue to be executed by the processor using the first subset and the second subset of nodes.

According to still another aspect of the present principles, there is provided a sequential discrete event simulator for a distributed system having a set of nodes. The simulator includes a processing element for performing the following steps. In a step, a priority queue is constructed that includes a plurality of events to be executed by a processor at a given node in the set. In another step, a first subset of nodes is identified. Each of the nodes in the first subset is associated with a respective subset of events determined from the plurality of events and includes a highest priority event there among whose priority must be unconditionally re-evaluated during a next time step. In yet another step, a second subset of nodes is identified. Each of the nodes in the second subset is associated with a respective other subset of events determined from the plurality of events and includes a highest priority event there among whose priority must be re-evaluated when a re-evaluation condition depending upon an external state is satisfied. In still another step, a next one of the plurality of events in the priority queue is selected to be executed by the processor using the first subset and the second subset of nodes.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIG. 2 shows an exemplary method 200 for performing top/pop and push operations, in accordance with an embodiment of the present principles;

FIG. 3 shows an exemplary method 300 for beginning a new event execution on a node, in accordance with an embodiment of the present principles;

FIG. 4 shows an exemplary method 400 for new event generation, in accordance with an embodiment of the present principles;

FIG. 5 further shows step 210 of the method 200 of FIG. 2, in accordance with an embodiment of the present principles;

FIG. 6 further shows step 210 of the method 200 of FIG. 2, in accordance with another embodiment of the present principles; and

FIG. 7 shows an exemplary simulator 700 to which the present principles may be applied, in accordance with an embodiment of the present principles.

### DETAILED DESCRIPTION OF PREFERRED EMBODIMENTS

As noted above, the present principles are directed to discrete event simulation using priority queue tagging. To that end, we are interested in a sequential (non-parallelized) discrete event simulation of distributed systems with a large number (N) of event-processing nodes. Within a simulation, selecting the “next” action must be done quickly. The inner loops of such simulators are based on priority queues, for which we desire to minimize the number of insert/erase operations. Many protocols can be simulated quickly, because selecting the next element can be decided based solely on the known event timestamps. However, some protocols require nodes to select a next operation in a fashion that depends upon a frequently changing state external to the node. For example, we are interested in simulating protocols where selecting the “next” action depends upon the current time, “now”. For example, the next action may depend upon some idle time threshold. We wish to support such protocols efficiently, in a manner which reduces the total cost of the priority queue operations required. It is desirable to determine the next action and its time by selectively re-evaluating the “next” actions at a bare minimum subset of nodes, in order to minimize the number of priority queue operations.

In an embodiment, by enumerating all possible combinations of queue states with respect to the current time within individual simulation objects, we have determined a set of conditions particularly efficient for correct determination of the next operation to be simulated. In an embodiment, correct and particularly efficient simulation can be achieved by maintaining the following two concepts: (i) a dirty-set of nodes which absolutely require re-evaluation at the next time step, whatever the value of current time is; and (ii) a conditionally-dirty set of nodes, whose decisions must be re-evaluated when “current time” of the discrete simulation can advance past some point. The net effect is to replace many queue insertion operations with operations on simpler data structures of small size and greater speed of operation. Thus, we are advantageously able to simulate a class of queuing policies (amongst other applications) for distributed systems within a discrete event simulator in a fast and efficient manner.

We note that events within a discrete event simulator include a time stamp and a destination, and may include a description of a particular command whose actions are to be simulated at the destination. Within the context of discrete event simulation, simulating an event is referred to as event execution. The time stamp may be used to order events, typically as items within a priority queue data structure, so that events execute in correct sequence.

As events are executed, simulated time typically moves forward incrementally, in time steps. By maintaining causal relationships between events, sufficiently accurate time stamping, correct sequencing, and sufficient accuracy in modifying state variables, a discrete event simulation may be used to model the behavior of complex physical systems. In addition to priority queues of the discrete event simulator, destinations of events (nodes) themselves may have priority queues whose effect is to be modeled.

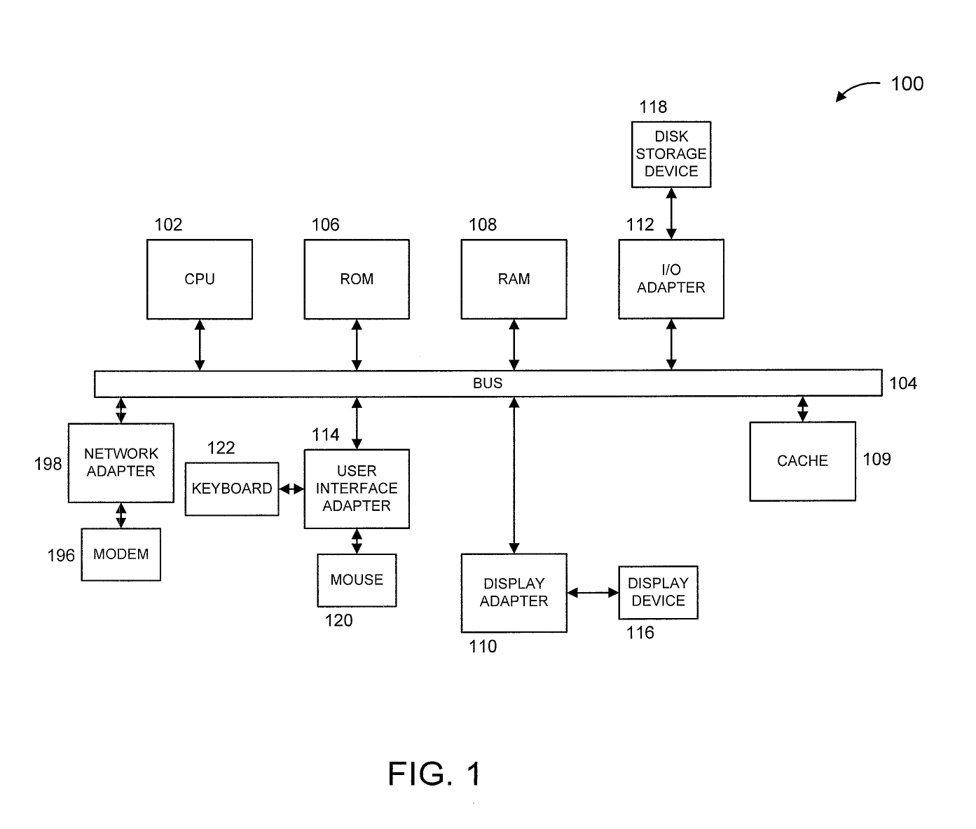

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 102 operatively coupled to other components via a system bus 104. A read only memory (ROM) 106, a random access memory (RAM) 108, a display adapter 110, an I/O adapter 112, a user interface adapter 114, and a network adapter 198, are operatively coupled to the system bus 104. We note that the processor 102 may also be interchangeably referred to herein as a processing element.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 114. The mouse 120 and keyboard 122 are used to input and output information to and from system 100.

A (digital and/or analog) modem 196 is operatively coupled to system bus 104 by network adapter 198.

Of course, the processing system 100 may also include other elements (not shown), including, but not limited to, a sound adapter and corresponding speaker(s), and so forth, as readily contemplated by one of skill in the art.

In order to illustrate an embodiment of the present principles, consider simulating N nodes in a distributed network where each node has foreground and background queues and each node implements a policy of running a background task if the foreground queue is empty or is idle for at least a particular length of time. Hence, the N nodes with queues are represented as follows, where “f” indicates a foreground queue and “b” indicates a background queue: 1f, 1b; 2f, 2b; . . . ; and Nf, Nb. The proposed “next” (item, time) is represented as follows: (i1, t1); (i2, t2); . . . ; and (iN, tN). One prior art approach would update all “next” items to be valid for time “now”. In contrast, in accordance with an embodiment of the present principles, we use a dirty set and a conditionally dirty set, as described in further detail herein below, to determine the earliest “next” action, which executes and may push new actions onto queues. Thus, in accordance with an embodiment of the present principles, while pushing as mentioned above, we update the dirty set and the conditionally dirty set. We note that the use of dirty sets allows us to keep the re-evaluation of queuing priorities to a minimum and leads to a reduction in the number of queue-modifying events.

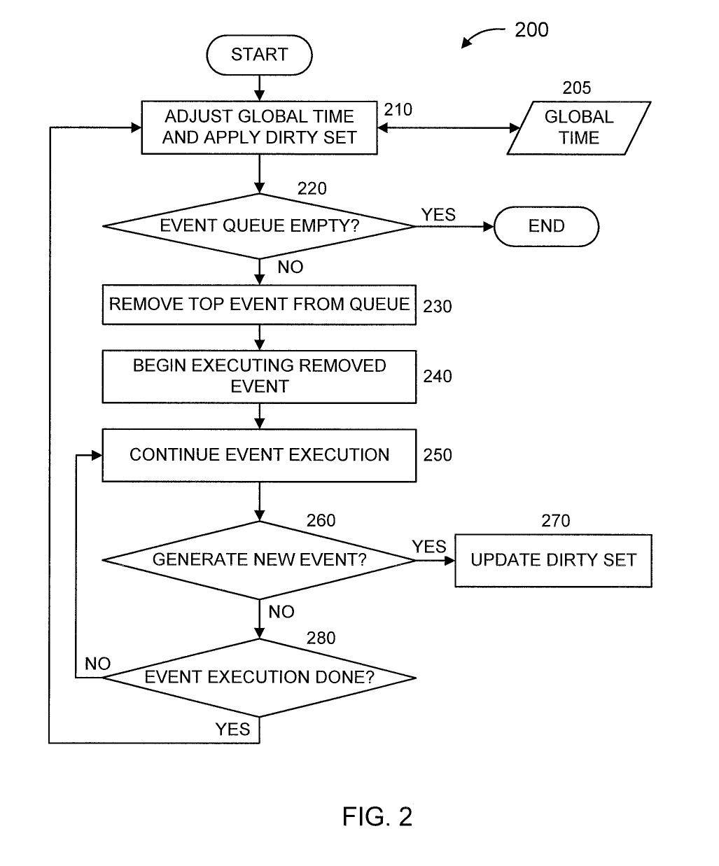

FIG. 2 shows an exemplary method 200 for performing top/pop and push operations, in accordance with an embodiment of the present principles. At step 205, global time is made available for use by the method. At step 210, global time is adjusted and a dirty set is applied. At step 220, it is determined whether or not an event queue is empty. If so, then the method is terminated. Otherwise, the method continues to step 230. At step 230, the top event is removed from the queue. At step 240, execution of the removed event is begun. At step 250, event execution is continued. At step 260, it is determined whether or not to generate a new event. If so, then the method proceeds to step 270. Otherwise, the method continues to step 280. At step 270, the dirty set is updated and the method returns to step 250. At step 280, it is determined whether or not the event execution is done. If so, then the returns to step 210. Otherwise, the method returns to step 250. We note that steps 205, 210, 220, and 230 pertain to top/pop operations, and steps 240, 250, 260, 270, and 280 pertain to push operations.

We note that regarding top/pop and push operations performed in accordance with the prior art, the same requires O(N) operations and/or O(N) messages. The approach of method 200 is significantly faster. For example, when adapting the queuing policy for use in a simulation, only a fraction of the items pushed onto the queues result in a bounded (O(1)) # of entries in the dirty set, and the expected number of active events in the conditionally-dirty set (1b) is smaller.

When to insert items into the 2 dirty sets will vary according to the policy that is being simulated, and is a nontrivial separate issue. The mechanism to use the dirty sets to determine the next action involves loops over a small number of items and, in an embodiment, may be implemented according to the following pseudocode:

```
    Maintain node-specific “next” candidates
    For all O(1) unconditionally dirty nodes {
        re-evaluate “next” candidate for dirty node
    }
    Clear unconditionally dirty list
    For all O(1) conditionally dirty nodes whose time is < now {
        re-evaluate “next” candidate for dirty node
        delaying any modifications of the conditionally dirty list until
after this loop
    }
    Select the node-specific “next” event of minimum timestamp, O(1).
```

The general principle is to delay global queue operations as long as possible, in the meantime maintaining a very small set of dirty nodes instead. When global event queue modifications do occur, they are undertaken en masse, with a correct value of the global simulation time being predetermined. For several distributed systems, this approach allows node-specific decisions to be made unambiguously, which can lead to increased efficiency of simulating such systems. With references to the Figures, we show how queue operations are, in general, delayed for as long as possible until a later point in the execution of the simulator, at which point the value of global simulator time can be accurately determined.

Again referring to FIG. 2, when we determine the top element in the global event queue and pop it from the global event queue, and we also determine the global time step and apply the dirty set before the top event is popped from the global event queue. After application of the dirty set, the global event queue is left in a state where all events are up-to-date. In keeping with this, during event execution, steps which might normally change the global event queue are replaced by simpler operations that remember the event and mark the destination node of the event as dirty.

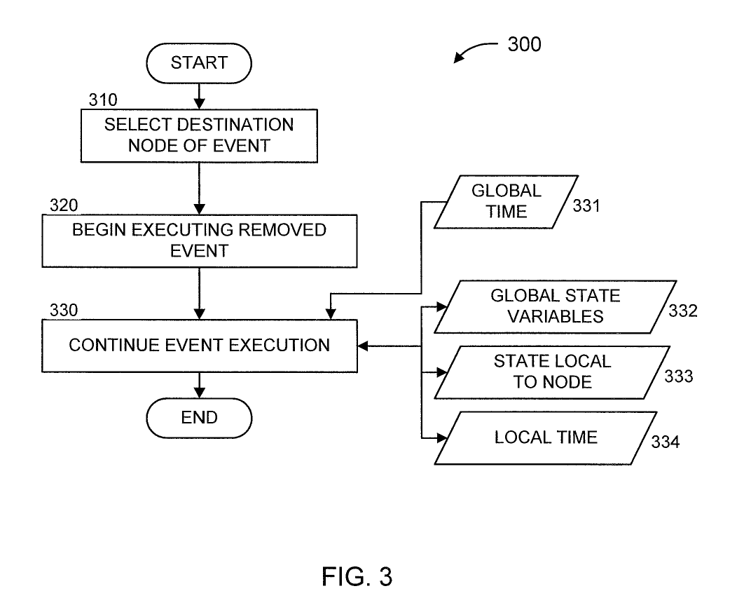

FIG. 3 shows an exemplary method 300 for beginning a new event execution on a node, in accordance with an embodiment of the present principles. At step 310, a destination node of an event is selected. At step 320, the selected node is marked as “dirty”. At steps 331, global time is made available for the method 30. At step 332, global state variables are made available for the method 300. At step 333, the state that is local to the node is made available for the method 300. At step 334, the local time is made available to the method 300. At step 340, the event for the selected node is executed in consideration of the global time, global state variables, the state that is local to the node, and the local time.

Hence, when a removed event begins execution, the method 300 uses a marking step which simply records the destination node of an event as being dirty. We note that in method 300, no attempt is made to ascertain the next event particular to a node, and no attempt is made to maintain an up-to-date global event queue, as might be typical in prior art approaches. The determination of a correct event specific to a particular node is instead to be done later, during the “Adjust global time and apply dirty set” step (i.e., step 210) of FIG. 2.

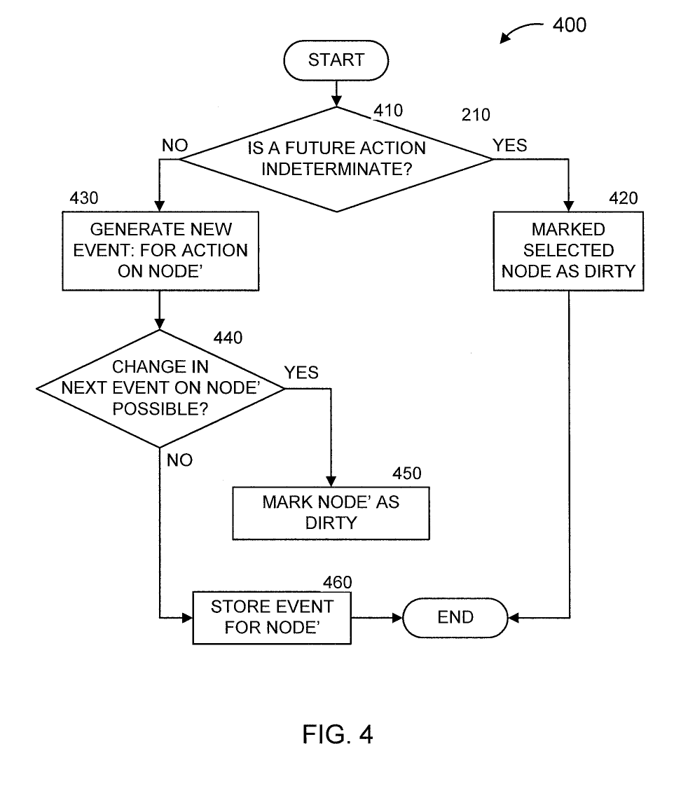

FIG. 4 shows an exemplary method 400 for new event generation, in accordance with an embodiment of the present principles. At step 410, is it determined whether or not a future action is indeterminate. If so, then the method proceeds to step 420. Otherwise, the method proceeds to step 430. At step 420, the selected node is marked as dirty. At step 430, a new event is generated for action on node′. At step 430, it is determined whether or not a change in the next event on the node′ is possible. If so, then the method proceeds to step 450. Otherwise, the method proceeds to step 460. At step 450, the node′ is marked as dirty. At step 460, the event for the node′ is stored. We note that step 420 specifically pertains to a node, while steps 430, 440, 450, and 460 pertain to another node distinguished from the node by the nomenclature node′.

FIG. 4 shows that during event execution, marking operations are used. Note that for message-passing protocols which terminate, the expected size of the dirty set that gets applied in FIG. 2 is often two (one dirty node that popped the message, as in FIG. 3, and an average of one reply or request rerouting to a subsequent simulation node). More rarely, event handling may generate a number of additional sub-requests, for example, to simulate parallelizable sub-operations.

Within FIG. 4, the marking of a selected node dirty for an indeterminate future action creates a conditionally dirty entry in the dirty set, whose later application (in FIG. 1) is to be done conditional on global simulation time having advanced past some threshold, future value. The dirty set entries for node′ in FIG. 4 and for node in FIG. 3 are unconditionally dirty entries, requesting re-evaluation of the proper next element unconditionally during the application of the dirty set in FIG. 1. In FIG. 4, the storage of an event for its destination node has common complexity and may involve node-specific priority queue operations of bounded O(1) size. In FIG. 4 updates of the global event queue are entirely avoided. Some generated events may even skip this storage step. Yet other execution paths may generate no dirty set operations at all. For example, an event E destined for a node′ may be able to guarantee no change in a next element known to be already correctly inserted into the global event queue. The destination node of event E need not be marked dirty. This case can occur more frequently if the event processing at nodes is lagging, per-node queues are large, or the event E is scheduled in the far future.

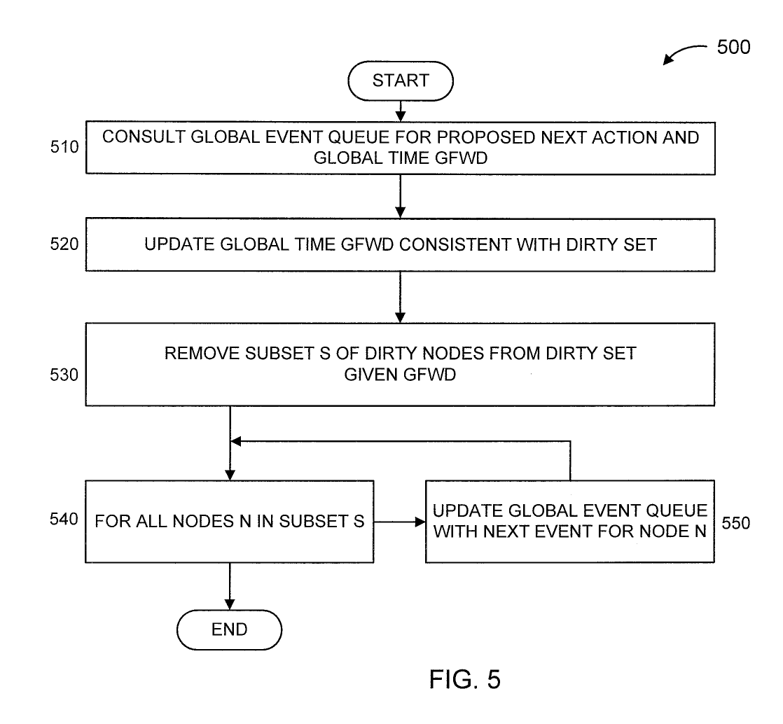

FIG. 5 further shows step 210 of the method 200 of FIG. 2, in accordance with an embodiment of the present principles. At step 510, the global event queue is consulted for the proposed next action and the global time gFwd. At step 520, the global time gFwd is updated to be consistent with the dirty set. At step 530, the subset s of nodes that are dirty given gFwd from the dirty set are removed. At step 540, a loop is commenced for all nodes n in the subset s, upon the completion of which the method is terminated. At step 550, which is within the loop commenced at step 540, the global event queue is updated with the next event for node n.

Hence, conceptually, the steps taken during the “Adjust global time and apply dirty set” step (i.e., step 210) of FIG. 2 are expanded within FIG. 5. First the existing events in the global queue can provide an initial estimate of the next global simulator time. The estimate is then iteratively updated to account for unconditionally dirty and conditionally dirty nodes in the dirty set, until a correct minimally-forward global simulation time can be agreed upon. Once the correct global simulation time, gFwd, has been determined, a dirty subset of nodes, s, is determined as the set of all unconditionally dirty nodes, augmented by the set of nodes dirty becoming dirty at time gFwd. These nodes are removed from the dirty set, their correct next actions determined, and updated within the global event queue. After this procedure, the “top” element of the global event queue is correctly determined and may be removed (as per step 220 in method 200 of FIG. 2).

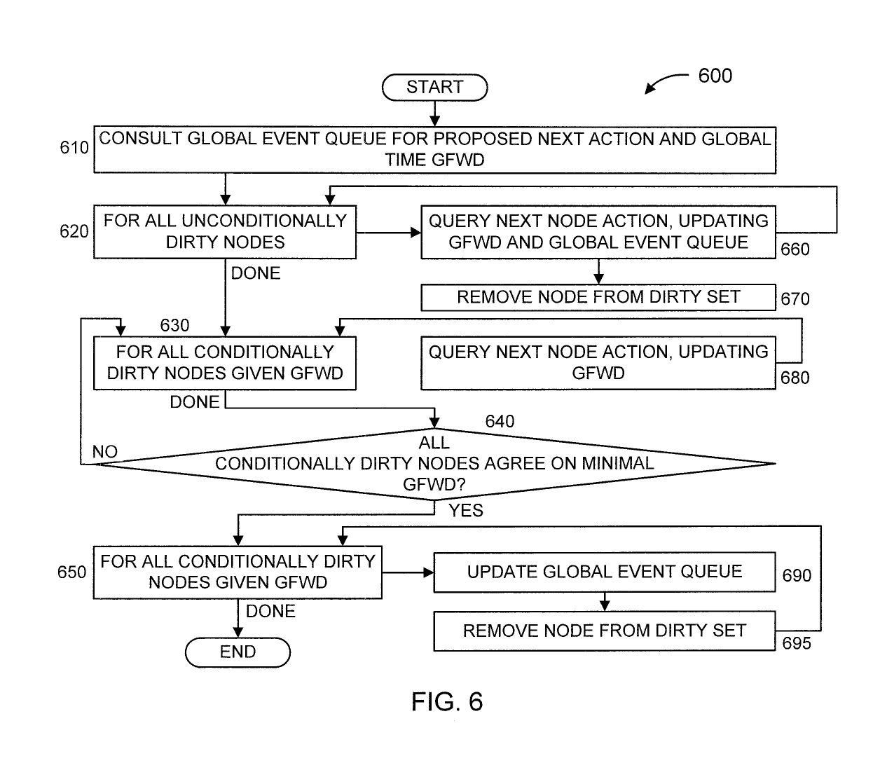

It is to be appreciated that some of the steps of FIG. 5 may be alternately arranged for efficiency as shown in FIG. 6. FIG. 6 further shows step 210 of the method 200 of FIG. 2, in accordance with another embodiment of the present principles. At step 610, the global event queue is consulted for the proposed next action and the global time gFwd. At step 620, a loop (hereinafter “first loop”) is commenced or all unconditionally dirty nodes. The first loop is iteratively performed for steps 660 and 670. At step 660, the next node action is queried, and gFwd and the global event queue are updated. At step 670, the node is removed from the dirty set. At step 630, which represents the completion of the loop commenced at step 620, another loop (hereinafter “second loop”) is performed for all conditional dirty nodes. The second loop is iteratively performed for step 680. At step 680 the next node action is queried, and gFwd is updated. At step 640, it is determined whether or not all conditionally dirty nodes agree on a minimal gFwd. If so, then the method proceeds to step 650. Otherwise, the method returns to step 630. At step 650, yet another loop (hereinafter “third loop”) is performed for all conditional dirty nodes given gFwd. The third loop is iteratively performed for steps 690 and 695, upon the completion of which the method is terminated. At step 690, the global event queue is updated. At step 695, the node is removed from the dirty set.

It can be shown that the expected number of global queue operations is decreased by the new mechanisms. Some of the global queue operations can be obviated completely by avoiding the speculative generation of global event queue operations. Other global event queue operations can be viewed as being replaced by extremely efficient operations on a dirty set whose number of entries is usually O(1) (often just two entries).

Notice that the benefits of the proposed approach are especially attractive in cases where the simulated systems have decisions which are indeterminate at the time of event/message generation, but can be correctly determined given a later time and later system state. For situations in which proper event ordering is not a function the global time, other approaches can also provide reasonable treatment. For example, node state changes can be signaled by explicitly monitoring external state variables and signaling such changes to nodes, which react by changing their code execution path. This approach is reasonable if the frequency expected for such node state changes is low.

We now note some advantageous features over the prior art. One such feature is that a node-specific “next” depends on an external parameter (“now”). Another such feature is that the external parameter changes frequently (“now” increases monotonically). Yet another such feature is that the maintenance and use of dirty sets.

We note that the present principles advantageously avoid the obvious method of re-evaluating all dynamic priorities at every time step (or an O(N) number of timing messages), or inefficiencies inherent using self-messaging (or finite state machine wrappers encapsulating self-messaging). These and other features and benefits of the present principles are readily apparent to one of ordinary skill in the art in consideration of the teachings of the present principles provided herein.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

In an embodiment, our discrete event driven simulator is architected as a graph, with each node being an object that abstracts one or multiple storage system components in the real world, for example, a cache, a disk, or a volume manager, and so forth. The core of our sequential, discrete event simulator is a global message queue from which the next event to be processed is selected.

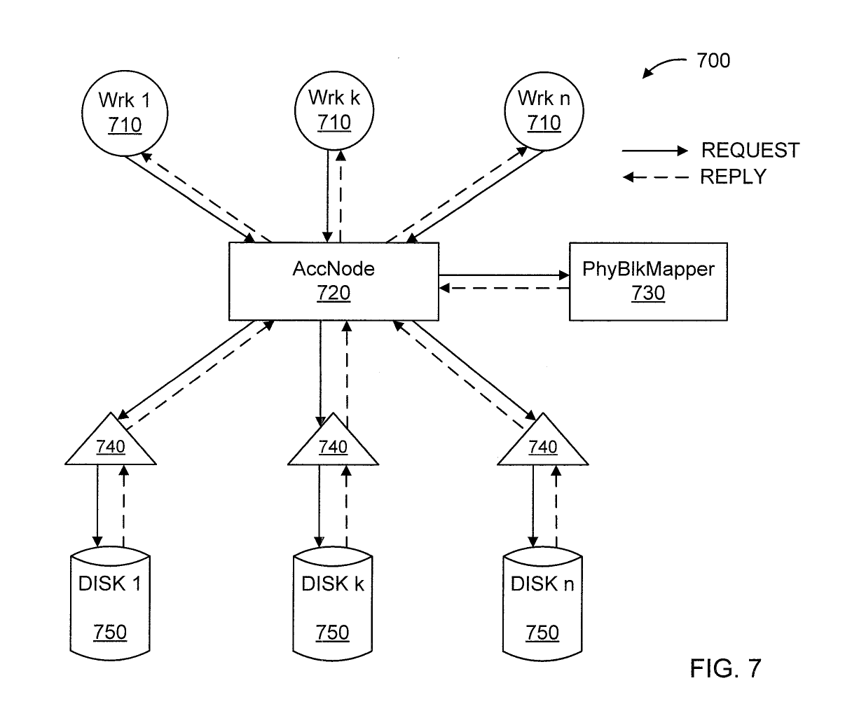

We now describe the abstracts we have taken of the complex world. FIG. 7 shows an exemplary simulator 700 to which the present principles may be applied, in accordance with an embodiment of the present principles. The simulator 700 includes workload model/objects and TracePlayer objects (also collectively designated by “Wrk” in short) and collectively represented by the figure reference numeral 710, an access node object (also designated by “AccNode” in short) 720, a physical block mapper object (also designated by “PhyBlkMapper” in short) 730, disk wrappers (e.g., caches, including, e.g., LRU cache objects and GlobLru objects) collectively represented by the figure reference numeral 740, and disk objects 750. It is to be appreciated that the elements of FIG. 7 and their respective configurations are merely illustrative and, thus, given the teaching of the present principles provided herein, other elements and configurations may also be used in accordance with such teachings, while maintaining the spirit of the present principles.

In an embodiment, a Workload model object 710 provides an implementation of a synthetic workload generator (for example, but not limited to, a Pareto distribution, etc.), while a TracePlayer object 710 implements a real trace player.

Briefly, AccNode 720 object handles receipt, reply, retry (flow control) and failure handling of client I/O messages, which involves the following tasks: (1) locks client accesses; (2) translates logical block addresses to physical ones (by querying the PhyBlkMapper object); (3) routes I/O requests to the correct cache/disk destinations; (4) manages the global cache; and (5) provides writes-offloading.

From the real world simulation point of view, task (1) simulates the protocol of client-lock manager that provides appropriate locks for each client's READ/WRITE/ASYNC WRITE operations. Task (2) simulates the protocol of client-volume manager that provides block address mapping, volume id query. The simulation does not implement a distributed logical to physical block mapping, which might be required for scalability, and in some real implementations this could involve an additional network round trip. Task (3) simulates the protocol of client-cache layer/block based storage device. In reality, the AccNode 720 would likely be implemented in a distributed fashion, behind a fairly dumb router. Task (4) simulates the protocol of client-cache manager that supports Read/Write/Erase operations on a global cache, which is a rough abstraction of real cache mechanism to support locked transactions. It is not meant to simulate a large-scale distributed global cache. Instead, we utilize this global cache to support our post-access data block swapping as well as write-offloading mechanisms. Task (5) simulates the protocol of client write offloading manager which switches workload to a policy-defined ON disk. In addition, AccNode 720 also supports simulation of special control message flows such as adapt-hint which is needed in promotion-based caching scheme. So far we only have single AccNode object, but a more accurate abstraction would allow more than one AccNode to cope with large number of clients.

In general, PhyBlkMapper 730 provides the following tasks: (1) maps logical address ranges to physical disks; (2) translates logical address to physical address for both the current mapping and a default mapping (i.e., the mapping before block swapping); (3) stores the global cache data; and (4) supports background tasks associated with block swapping and write offloading.

Tasks (1) and (2) are an abstraction of a volume manager. Background tasks are tasks out of the fast path of a client request→reply chain. Task (4) supports swapping the content of two logical blocks between two physical content locations. Task (4) simulates the background task portion of write offloading. Our write offloading scheme currently assumes a single step for the read-erase-write cycle in dealing with writing empty blocks but in another implementation, we use two separate read and write operations.

An LruCache Object 740 is an abstraction of a LRU cache. Particularly, it has two important derivations PROMOTE-LRU and DEMOTE-LRU caches. PROMOTE-LRU and DEMOTELRU support promotion-based and demotion-based policies respectively. We did not simulate internal caching layers.

A GlobLru Object 740 models a content-less LRU list of block-ids which wraps all accesses to a single slave disk. It supports query for a LRU/MRU block-id. A MRU block is the most recently accessed block in the slave disk. Correspondingly, a LRU block is the least recently accessed block in the slave disk. In addition, the block-ids not in the LRU list are considered to be with empty blocks, since they have not been accessed yet. GlobLru is useful as a component in block relocation schemes, where its main function is to select an infrequently used (hopefully empty) block.

A disk object 750 models a block-based storage device. It is the terminal node in our simulator graph, meaning that a disk never receives replies from other ones. It is associated with an energy specification including entries for disk power in ON and OFF states, transmission power per I/O, TOFF_TON (time to turn disk ON, e.g., 5 seconds), TON_TOFF (time to turn disk OFF, e.g., 15 seconds). A disk object 750 also specifies read/write latencies that are internally scaled to estimate effects associated with random or sequential block access. The disk object 750 optionally stores a mapping of a block-id to content identifier, for verifying correctness (especially when simulating multi-level distributed caching) and allowing an existence query for other debug purposes. On the other hand, when the simulation scale is very large, too much memory would be consumed if content identifiers were stored.

Regarding advantages of using simply models, our simulator chooses simple, approximate models primarily for two reasons: simulation speed; and focus on high-level system design. This approach also allows fast simulation of larger-scale systems of interest.

Yet another advantage to early simulation lies in uncovering engineering issues and rare test cases. Even with a moderate number of software components, distributed systems can exhibit rare failure cases that in real-world testing can be very hard to reproduce, particularly if they depend on the conjunction of several unfortunate events. Finding at evaluating engineering fixes at simulation stage is vastly preferably to late discovery of such rare bugs that could require re-architecting portions of a running system. Our simulator is entirely reproducible and, thus, is useful in uncovering, for example, rare combinations of I/O patterns and disk states that lead to particularly bad interactions between the queuing system, the lock manager, and particular block placement policies. Such events form valuable test cases, and testing for rare events in the context of the simulator is significantly easier than debugging rare events in somewhat non-reproducible real distributed systems.

Note that the simulator is adaptable to more than just developing a block device. By changing the concepts of block-id and content, the graph-based message-passing simulation can simulate object stores, file system design, content addressable storage, key-value and database storage structures, and so forth.

The simulator saves memory by using placeholders for actual content to test system correctness, but can run larger simulations by providing alternate implementations of some components that simply do not care about, and consequently avoid storing, any content. Similarly, in comparing data placement policies, client working set sizes can be kept small to lower memory usage, and disk speeds and I/O rates can be scaled down (within bounds of not significantly affecting the variance of I/O rates on time scales of a few seconds).

Also, because of the intended slop we are allowing in calculating millisecond-level time delays, abstractions of distributed system components with which we are familiar can be simplified. Message delays only need incorporate an approximately correct number of network delays, since our uncertainty in disk latency is already a larger and less systematic error source.

Regarding event simulator internals, the message queue is implemented as a priority queue, but for some policies the message queue is augmented by a data structure that includes dirty set entries for: (1) simulated nodes whose highest priority item must unconditionally be re-evaluated during the next time step; and (2) simulated nodes whose highest priority item must be re-evaluated conditional on the simulation time advancing past a certain point. For example, a queuing policy which runs background storage operations during foreground idle times has been shown to be quite useful on single storage nodes, but simulating such policies poses some efficiency concerns since it is regularly impossible to decide upon a correct action until global time has advanced further into the future. These dirty set entries are simulation optimizations that can allow some time-dependent policies to bypass a large number of event queue “alarm” signals with a more efficient mechanism. Just as many graph algorithms avail themselves of graph “coloring” schemes, a node-dirtying scheme can help the efficiency of graph operations to determine the global next event.

Since our simulator focuses on energy aspects of the storage system, it is expected to handle events like disk spin-up and spin-down, which may alter the ordering of events in the queue and change the energy states of related nodes. Here again, certain self-messages can be avoided by instead providing a retroactive update mechanism. For example, consider an event for a message sending to a disk which is currently OFF. If the time period between this message arrival time and the last known device status time is longer than disk spin-down time, the disk would have turned OFF during the period and requires a retroactive update recording the new device state, the time of the device state change (e.g., remember that the disk is OFF at time t and begins to turn on at a later time) and corrections to cumulative statistics. In addition, such an event (message arrival) will advance the node's local timestamp and make the disk busy for a spin-up time period.

The price paid for such speedups is some degree of code complexity to maintain retroactively updated statistics properly and apply the dirty-set information so as to advance global simulation time correctly, as compared to alternative finite-state-machine or alarm-based approaches. Particularly, the implementation of the node-local queues must be done with greater care to avoid using unknowable “future information” and unwittingly simulate an unrealizable physical system.

Regarding regimes of validity of our simulator, we note that the energy modeling of disk accesses only represents only ON and OFF power states of a magnetic disk drive. In addition, it does not include explicit modeling of block location and has a very crude estimation of I/O latency. In fact, in our simulation we try to adopt an approximation of random-access speed unless the determination of a state of being sequential is easily obvious in the I/O stream, so that our millisecond latency estimates and TOPS estimates should at least err on the side of caution.

Although we included energy contributions from all simulated components, it is useful to consider a simple energy usage model for the largest contributor, disk power, as follows: total energy usage Eₜₒₜ=P_{ON}·t_{ON}+P_{OFF}·t_{OFF}, where P_{ON}, P_{OFF} are power usage for ON and OFF power states respectively and t_{ON}, t_{OFF} are the corresponding ON-time and OFF-time. As for error estimates, we assume that ΔP_{OFF}<ΔP_{ON}. Therefore, the dominant approximation errors for total energy usage arising from ΔP_{ON} and Δt_{ON}. ΔP_{ON} and P_{ON} are likely to reflect systematic errors when policies change, whereas t_{ON} is expected to be highly dependent on the block relocation policy itself. When analyzing our simulation results, one should verify that t_{ON} indeed contributes a significant portion of the storage energy. With the preceding achieved, analysis can then focus on comparing one energy saving policy with another rather than on obtaining the absolute energy savings of any one policy. In the regime where latency is governed by outlier events that absolutely have to wait for a disk to spin up, we consider approximation errors in t_{ON} negligible. The origin of this lies in the simple fact that disk spin-up is on a time scale 3-4 orders of magnitude larger than typical disk access times. One expects less accuracy for simulating multi-speed disk drives where changing energy state has fewer orders of magnitude difference in time scale. By focusing our attention on events occurring on time scales of seconds, it is possible for errors on the level of milliseconds (ms) for individual I/O operations to contribute negligibly to block relocation policies governing switching of the disk energy state. This approximation holds well in the low-IOPS limit, where bursts of client I/O do not exceed the I/O capacity of the disk. In this regime, accumulated approximation errors in disk access time remains much smaller that the disk state transition time and especially less than the time of the disk OFF periods.

To summarize, we believe it reasonable to compare different block relocation policies within crude simulation models if we assume: (1) low client TOPS, where bursts of client I/O do not exceed the I/O capacity of the disk for extended periods; and (2) fragmentation effects at the level of individual disks can, in future implementations, be kept similar as these policies are extended to include disk-level block arrangement.

The first assumption can be verified with the traces used. The second cannot, without explicitly extending the block swapping policies to consider detailed disk layout. However, even at the level of block remapping policies, some policies would be preferred than others because it may introduce a lesser amount of intrinsic fragmentation.

The other accuracy issues relate to the sensitivity of policies to system statistics. In this case, any sort of hard threshold in an algorithm may give large error in results if client traces exercise those thresholds too little. Sensitivity analysis of results to policy thresholds/parameters were conducted, as well as investigating a wide range of client access behaviors. Policies whose performance is particularly sensitive to thresholds or assumptions about client access load or pattern should be avoided.

Most quality of service (QoS) indicators should be treated with caution for at least the following reasons: a block relocation policy must react well to “easy” QoS indicators such as outlier events (e.g., latencies at second-level, the number of disk-ON events, very high/low disk TOPS), but little confidence should be accorded to ms-level performance. After a few classes of block relocation policies can be identified, then it makes sense to further consider disk-level effects such as actual block placement and disk-level simulation (of at least a few drives within the distributed system) to discern the true level of random versus sequential access, reacting with appropriate online defragmentation mechanisms and so forth that will be important in real systems.

Some of the design features of the present principles will now be described. The energy usage of a storage system is largely determined by the energy consumed in disks. It is usually assumed that within a given time period, workload will only span a small portion of the overall disk blocks. However, in many case the workload could span a large set of disks and it is energy inefficient to keep all the disks ON all the time. Write-offloading schemes shift the incoming write requests to one of the ON disks temporarily when the destination disk is OFF and move written blocks back when the block is ON later (e.g., a disk is ON due to an incoming read request). This approach requires a provisioned space to store offloaded blocks per disk and needs a manager component like a volume manager to maintain the mapping of offloaded blocks and the original locations. We achieve write workload offloading with a block relocation approach. Block relocation is a permanent change of the location of a block. On the other hand, maintaining permanent block location changes may impose a higher mapping overhead for the volume manager. Luckily, in a real implementation, such overhead could be mitigated by introducing the concept of data extent (i.e., a sequence of contiguous data blocks) at a volume manager who is then instructed to swap two data extents rather than two data blocks among two disks. We develop a series of block relocation policies using the simulator, that for low additional system load result in fast dynamic “gearing” up and down of the number of active disks.

Tackling energy efficiency presents different data relocation issues when addressed at a file system or block device level. For example, a file system has the concept of unused blocks and used ones, whereas a block device cannot distinguish between them. Therefore, to move a block from one disk to another is simplified for file systems, as long as there exists sufficient unused blocks at the destination disk. For block devices, lacking a concept of free blocks, we have adopted an internal block swap transaction as an internal primitive for block devices. Selecting block swap destinations becomes a task of selecting a perhaps-free block (i.e. a less-recently-used block).

Another difference is that file systems are usually designed to be able to handle fragmentation issues, being able to use higher level concepts of file and directory to group and sequence data blocks. Also, many modern file systems adopt the extent (a consecutive number of blocks) as a storage space allocation unit instead of single block to mitigate the degree of fragmentation and retain a reasonable degree of sequential access. Thus, data relocation policies within file system could try to relocate at extent level if possible to keep the fragmentation degree after relocation low. On the other hand, block devices are restricted to grouping data based on logical address and temporal access sequence. Data relocation at block devices at a large logical-block extent level can lead to inefficiency as more blocks than strictly necessary may be involved in background data swapping. However, relocation at a small-block level can lead to fragmentation. For example, temporal interleaving of writes from multiple active clients risk giving each client a somewhat non-continuous access pattern for later reads, unless this is detected and avoided, or defragmented during less busy periods. Furthermore the spread of blocks from any single client should be kept under control. A small spread of client blocks to physical disks can be beneficial to achieve data striping, whereas a large spread of client blocks across system disks can fundamentally constrain the number of ON disks required for sequential data access.

For a holistic simulation of energy usage at all levels, two different definitions of client models are adopted. From the viewpoint of storage system behavior, a useful definition of a client is access to a sequential range of logical blocks, like an extent/sub-volume/partition of a disk, because it helps to identify correlation among block access patterns as well as disk-level fragmentation issue (e.g., how many target disks are spanned by a client's footprint). These measurements are crucial in driving dynamic block placement policies. On the other hand, to model the client behavior such as I/O burstiness and ON/OFF pattern, our simulator also includes use statistical models within the simulator.

We now describe a block-swap operation. To support block relocation for block devices, we propose a new block operation block-swap which swaps the content of two physical blocks. A block swap transaction involves multiple I/Os and does not change the content of corresponding logical blocks. For example, supposing LBA₁,LBA₂ are logical block addresses (LBAs) and PBA₁ and PBA₂ are the corresponding physical block addresses (PBAs), before block swapping we have LBA₁→PBA₁ and LBA₂→PBA₂. After the block swap, we will have LBA₁→PBA₂ and LBA₂→PBA₁. Block swapping is transparent to clients since the content located by LBA remain unchanged, and clients always access through LBA. A block swap can reduce disk I/O burden if the content to be swapped is already present in cache.

We note describe locking behavior for block swapping. To support block swapping, a lock manager is required to handle 3 types of locks. A read lock is a shared type lock indicating that multiple read-locks could be held simultaneously on an object (e.g., a LBA). Naturally, a read-lock would not modify the content of the locked object so that it could not be held together with write-lock. A write-lock is an exclusive type lock and at any time there is at most one write-lock allowing a hold on an object. The content of an object 1 could be modified by the lock owner once the write-lock is granted. For debugging and error logging it was convenient to use the locking scheme to signal additional states. For example, a swap-lock was introduced as a special locking mechanism to support block swapping. Distinct from a write-lock that also grants exclusive access, a swap-lock does not change the content of a locked logical block before and after the locking procedure. For example, let SL represents swap-lock operation and A1 be a to-be locked LBA and suppose SL(A1) returns successfully and then the policy caches the content of A1 somewhere else (e.g., in a LRU cache), then A1 remains read accessible through the swapping procedure without breaking the data consistency. A swap lock thus behaves like a read lock from the perspective of client code (logical block), allowing other client reads to proceed from cached content. However, internal reads and writes for the swap behave as write-locks for the physical block addresses involved.

Block swapping must take care to avoid data races and maintain cache consistency as I/O operations traverse layers of caches and disks. Consider a block swapping policy trying to initiate a background block-swap operation after a foreground block read on a block, say LBA A1. When the read finishes, the content is known, but other read-locks may exist, so AccNode 720 checks the number of read-locks on this block. If there are no other read-locks existing, the read-lock may be upgraded to a swap-type lock. Thereafter, AccNode 720 determines which disk the block should swap to and sends message to the corresponding disk wrapper GlobLru 740 for a pairing block A2 (and hopefully it is an empty block). When AccNode 720 receives the affirmative reply from GlobLru 740, it could be sure that the pairing block A2 has been swap-locked already. Next, AccNode 720 signals PhyBlkMapper 730 to request a block-swapping operation. Upon receiving the request, PhyBlkMapper 730 first issues one background read A2 and later, block contents both known, issues two background writes after the read returns successfully. When the block swapping is done, cached copies for swapping would be removed and swap-locks on the swapping pair would be dropped. Swap locks also allow write-offloading to be implemented conveniently.

Furthermore, as a performance improvement strategy, block swap policies could swap block extents instead of two single blocks. Correspondingly, our lock manager also handles swap-lock grant/revocation for a vector of blocks.

We now describe simulator optimization for foreground and background operations. A major usage of our simulator is to evaluate various data block relocation policies. A common characteristic of all these policies is that they are required to be able to handle data block operations at different priorities. For example, ordinary block read/write operations issued by clients should have fast response while block swaps should be handled outside the fast path of responding to a client request. A foreground/background queuing model fits well here in the sense that read/write operations are issued as foreground operations while block-swaps are issued as background ones.

The following shows pseudocode for a swapping policy in accordance with an embodiment of the present principles.

```
getOnDisk(i)
origIops←getIops(i) ;
ioRates←getDiskIops(dk) ;
if ∃job(s,i)in jobLo1
  if origIops > α · diskCap[i]
    jobLo1.erase(job(s,i));
  else
    if PowerState[s] == OFF
      jobLo1.erase(job(s,i));
    else
      return 0; //skip swap
if ∃job(i,d)in jobLo1
  if origIops > β · diskCap[i]
    jobLo1.erase(job(i,d));
  else
    return d;
if origIops < γ · diskCap[i]
  if ∀disk j ioRate [j] < origIops
    break;
if j ≠ i AND PowerState[j] == ON
  if ioRates [j] +origIops < δ · diskCap[j]
    create job(i,j);
    jobLo1.push_back(job(i,j));
    return j;
```

A so called job-list structure is proposed to provide a bunch of promising descending directions in which our energy state could move toward. Each element of the job list is a pair of disk identifiers (from, to). In the pseudocode, we show a piece of our decision-making routine that returns either the swap-to disk id for a given block or a 0, the latter indicating skipping swapping for this block. i is the disk-id of the original destination for that block. dk is the historical time period we obtained the activity statistics. ioRates is implemented by STL Multimap and is, thus, sorted. The entire decision-making routine maintains 3 job lists, but here we only present one JobLo1 because all lists are handled following a similar logic. α, β, γ, δ are constant factors regarding to disk throughput capacity.

The key concept is to activate/deactivate background block-swap jobs when it is really obvious something needed fixing.

Some hysteresis is built in so jobs persist until a bit after whatever was bad has been made better. We do not want jobs toggling too often, or clustered accesses might get “spread” over too many target disks. On the other hand, background jobs persisting too long may affect the overall QoS. In order to address this stiffness, it is desired to allow scheduled block-swap jobs to be done (or even canceled) in a much later time without affecting the read/write performance.

To address these challenges, we have investigated two message queuing models in our simulator design. A simple FIFO model can be simulated by a single global queue, whereas a more complex foreground/background queuing model could handle foreground and background operations separately. We found that using foreground and background message queues also required more sophisticated lock management. Additional simulator complexity was introduced to efficiently handle simulation event scheduling that depended on using the global simulation time to make decisions about the idle time of foreground queue operations.

In the single queuing model, we found contention between client operations and block-swap operations accumulating for a disk in the process of turning on. One way to resolve such contention is to support multiple message priorities, where foreground client operations preferentially execute. Such a scheme has been shown to be particularly useful for storage when idle time detection of foreground operations is used to allow background tasks to execute. However, naively introducing such a queuing scheme showed that lock contention between foreground/background tasks was still occurring, even more frequently than before, and that changes to the locking scheme were desirable. In particular, it is useful for the initial read-phase of a background block-swap to take a revocable read lock. When a foreground client write operation revokes this lock, the background operation can abort the block-swap transaction, possibly adopting an alternate swap destination and restarting the block swap request. Revocable write locks present additional problems, so one approach is to simply make all writes foreground operations.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B).

As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims.

Having thus described aspects of the invention, with the details and particularity required by the patent laws, what is claimed and desired protected by Letters Patent is set forth in the appended claims.

What is claimed is:

1. A method for sequential discrete event simulation for a distributed system having a set of nodes, the method comprising:
constructing a priority queue that includes a plurality of events to be executed by a processor at a given node in the set;
identifying a first subset of nodes, each of the nodes in the first subset associated with a respective subset of events determined from the plurality of events and including a highest priority event there among whose priority must be unconditionally re-evaluated during a next time step;
identifying a second subset of nodes, each of the nodes in the second subset associated with a respective other subset of events determined from the plurality of events and including a highest priority event there among whose priority must be re-evaluated when a re-evaluation condition depending upon an external state is satisfied; and
selecting a next one of the plurality of events in the priority queue to be executed by the processor using the first subset and the second subset of nodes.

2. The method of claim 1, wherein the first subset and the second subset of nodes collectively include less than all of the nodes in the set of nodes.

3. The method of claim 1, wherein the re-evaluation condition is a global simulation time that has advanced past a time threshold.

4. The method of claim 1, further comprising configuring at least some of the simulated nodes in at least one of the first subset and the second subset to implement one or more queuing policies whose respective simulated operations rely upon a current time.

5. The method of claim 1, wherein the first subset requires the highest priority event included therein being unconditionally re-evaluated during the next time step, irrespective of a current time.

6. The method of claim 1, wherein the discrete event simulation is for a priority queuing system configured to model a plurality of priority queues disposed at various ones of the nodes in the set, the plurality of priority queues comprising high priority queues and low priority queues respectively including high priority events and low priority events relative to each other, and wherein each of the low priority queues is permitted to execute the low priority events only when the high priority queues are determined to be idle for a predetermined duration of time.

7. The method of claim 1, wherein an insertion time for any of the events associated with the nodes in the first subset and the second subset is dependent upon a given queuing policy to be simulated by the priority queue.

8. The method of claim 1, wherein at least some of the nodes in at least the first subset and the second subset comprise at least one of source nodes and destination relating to a given one of the plurality of events associated therewith.

9. The method of claim 1, wherein at least some of the nodes in the set represent a respective storage device.

10. A computer storage medium for storing programming code for a method for sequential discrete event simulation for a distributed system having a set of nodes, the method comprising:
constructing a priority queue that includes a plurality of events to be executed by a processor at a given node in the set;
identifying a first subset of nodes, each of the nodes in the first subset associated with a respective subset of events determined from the plurality of events and including a highest priority event there among whose priority must be unconditionally re-evaluated during a next time step;
identifying a second subset of nodes, each of the nodes in the second subset associated with a respective other subset of events determined from the plurality of events and including a highest priority event there among whose priority must be re-evaluated when a re-evaluation condition depending upon an external state is satisfied; and
selecting a next one of the plurality of events in the priority queue to be executed by the processor using the first subset and the second subset of nodes.

11. The computer storage medium of claim 10, wherein the first subset and the second subset of nodes collectively include less than all of the nodes in the set of nodes.

12. The computer storage medium of claim 10, wherein the re-evaluation condition is a global simulation time that has advanced past a time threshold.

13. The computer storage medium of claim 10, wherein at least some of the simulated nodes in at least one of the first subset and the second subset are configured to implement one or more queuing policies whose respective simulated operations rely upon a current time.

14. The computer storage medium of claim 10, wherein the first subset requires the highest priority event included therein being unconditionally re-evaluated during the next time step, irrespective of a current time.

15. The computer storage medium of claim 10, wherein the discrete event simulation is for a priority queuing system configured to model a plurality of priority queues disposed at various ones of the nodes in the set, the plurality of priority queues comprising high priority queues and low priority queues respectively including high priority events and low priority events relative to each other, and wherein each of the low priority queues is permitted to execute the low priority events only when the high priority queues are determined to be idle for a predetermined duration of time.

16. A sequential discrete event simulator for a distributed system having a set of nodes, the simulator comprising a processing element for performing the following steps:
constructing a priority queue that includes a plurality of events to be executed by a processor at a given node in the set;
identifying a first subset of nodes, each of the nodes in the first subset associated with a respective subset of events determined from the plurality of events and including a highest priority event there among whose priority must be unconditionally re-evaluated during a next time step;
identifying a second subset of nodes, each of the nodes in the second subset associated with a respective other subset of events determined from the plurality of events and including a highest priority event there among whose priority must be re-evaluated when a re-evaluation condition depending upon an external state is satisfied; and
selecting a next one of the plurality of events in the priority queue to be executed by the processor using the first subset and the second subset of nodes.

17. The sequential discrete event simulator of claim 16, wherein the first subset and the second subset of nodes collectively include less than all of the nodes in the set of nodes.

18. The sequential discrete event simulator of claim 16, wherein the re-evaluation condition is a global simulation time that has advanced past a time threshold.

19. The sequential discrete event simulator of claim 16, wherein at least some of the simulated nodes in at least one of the first subset and the second subset are configured to implement one or more queuing policies whose respective simulated operations rely upon a current time.

20. The sequential discrete event simulator of claim 16, wherein the discrete event simulation is for a priority queuing system configured to model a plurality of priority queues disposed at various ones of the nodes in the set, the plurality of priority queues comprising high priority queues and low priority queues respectively including high priority events and low priority events relative to each other, and wherein each of the low priority queues is permitted to execute the low priority events only when the high priority queues are determined to be idle for a predetermined duration of time.
